(19) United States
(12) Patent Application Publication
(10) Pub. No.: US 2026/0249947 A1
(43) Pub. Date: Aug. 27, 2026

(54) Method for Operating a Sensor System of an Electric Bicycle

(71) Applicant: Robert Bosch GmbH, Stuttgart (DE)

(72) Inventors: Astrid Rall, Leingarten (DE); Franz Hofmann, Besigheim (DE); Andreas Breitfeld, Stuttgart (DE)

(21) Appl. No.: 19/540,736

(22) Filed: Feb. 15, 2026

(30) Foreign Application Priority Data
Feb. 25, 2025 (DE) 10 2025 107 005.9

(51) Int. Cl. B62M 6/50; B62M 6/55; G01L 3/10

(52) U.S. Cl. CPC B62M 6/50; B62M 6/55; G01L 3/101

(57) ABSTRACT

A method for operating a sensor system of an electric bicycle is disclosed. The sensor system includes a torque sensor formed as a magnetoelastic sensor and configured to ascertain a torque on a shaft based on a detection of changes of a magnetic field. The method includes (i) detecting a homogeneous magnetic flux density by way of the torque sensor, (ii) ascertaining a torque on the shaft by way of the torque sensor, and (iii) detecting a torque error of the ascertained torque when the detected homogeneous magnetic flux density is greater than or equal to a predetermined first threshold value.

This application claims priority under 35 U.S.C. § 119 to patent application no. DE 10 2025 107 005.9, filed on Feb. 25, 2025 in Germany, the disclosure of which is incorporated herein by reference in its entirety.

### BACKGROUND

The present disclosure relates to a method for operating a sensor system of an electric bicycle, a method for operating a drive unit of an electric bicycle, and an electric bicycle.

Sensor systems of electric bicycles are known which have torque sensors that are based on the magnetoelastic principle. Based on detecting and evaluating physical quantities of a magnetic field in the region of a bottom bracket spindle, an instantaneous torque at the bottom bracket spindle may be determined by way of the sensor. In the presence of strong and, in particular, variable external magnetic fields, errors in detection of the torque may occur.

### SUMMARY

The method according to the disclosure having the features set forth below is characterized, in contrast, in that errors in detection of a torque at a shaft of an electric bicycle may be recognized in a simple and reliable manner. In particular, measures may be taken on that basis, in order to optimize subsequent reactions in the operation of the electric bicycle. According to the disclosure, this is achieved by a method for operating a sensor system of an electric bicycle, wherein the sensor system comprises a torque sensor. The torque sensor is formed as a magnetoelastic sensor, that is to say is configured to detect a torque based on the magnetoelastic principle. The torque sensor is configured such that, based on detection of changes in a magnetic field, a torque at a shaft is ascertained. The method comprises the steps of:
detecting a homogeneous magnetic flux density by way of the torque sensor,
ascertaining a torque at the shaft by way of the torque sensor, and
recognizing a possible torque error of the ascertained torque when the detected homogeneous magnetic flux density is greater than or equal to a predetermined first threshold value.

Preferably, the sensor comprises a plurality of sensor elements which are arranged next to one another, in particular, parallel to an axial direction of the shaft. More preferably, the magnetic sensor comprises three identically formed sensor elements.

In other words, in the method, at the same time as ascertaining the torque at the shaft based on the magnetoelastic principle of the torque sensor, a detection of a homogeneous magnetic flux density takes place, in particular, in the region of the shaft. If the detected homogeneous magnetic flux density reaches or exceeds the first threshold value, it is recognized that a possible torque error is present in the ascertained torque, that is to say that the ascertained torque may be faulty. That is to say, a magnitude of the instantaneous homogeneous magnetic field induced externally is detected by way of the torque sensor. If it is detected that a strong homogeneous magnetic field is present, the torque error is assumed. In particular, the method is based on the assumption that, in the presence of a strong homogeneous magnetic field, a significant inhomogeneous magnetic field is simultaneously present which has an influence on torque detection. For example, a strong inhomogeneous magnetic field may cause an overestimation of the actual torque at the shaft. That is to say, in the presence of a strong inhomogeneous magnetic field, the torque sensor may deliver, as a measured value, a higher torque than is actually present at the shaft.

The method is thus characterized in that it may be reliably ascertained, in a particularly simple and cost-effective manner, when torque errors are to be expected in detection of the torque at a shaft of the electric bicycle. Simple and cost-effective torque sensors may be used for this purpose. Since torque sensors, for example, frequently may not detect inhomogeneous magnetic fields directly, an alternative, particularly simple and cost-effective possibility may thus be provided, by way of which the presence of torque errors may be estimated based on the detected homogeneous magnetic fields. The knowledge about the torque errors may, for example, be further used to optimize operation of the electric bicycle.

Further developments of the disclosure are also set forth below.

Preferably, ascertaining the torque comprises compensating the homogeneous magnetic flux density. That is to say, the detected homogeneous magnetic flux density is factored out in ascertainment of the torque at the shaft and thus remains unconsidered in ascertainment of the actual torque. In particular, the torque sensor is configured to carry out compensation of the homogeneous magnetic flux density inherently by its construction and/or mode of operation. The torque that actually acts on the shaft may thus be calculated with particular precision.

Preferably, detection of the homogeneous magnetic flux density takes place along an axis of the shaft. More preferably, the homogeneous magnetic flux density is detected exclusively along the axis of the shaft. The torque may thus be ascertained precisely with a particularly simple and efficient design and mode of operation.

Alternatively or additionally, detection of the homogeneous magnetic flux density may take place along a plurality of different axes, preferably along a total of three spatial axes oriented orthogonally to one another. That is to say, the homogeneous magnetic flux density may alternatively preferably be detected three-dimensionally. A particularly precise ascertainment of the homogeneous magnetic flux density and also of the torque may thus be achieved.

Preferably, the first threshold value comprises a sensor-specific constant value which may preferably be set to a suitable value by way of an initial calibration and/or parameterization of the sensor system. A particularly simple and efficient implementation of the method may thus be enabled. More preferably, the first threshold value amounts to at least twice the homogeneous magnetic flux density of the Earth's magnetic field. This makes it possible to reliably detect that significant additional magnetic fields are present, which also exhibit inhomogeneous components that may cause deviations in torque ascertainment. For example, the first threshold value amounts to at least 100 μT.

Furthermore, the disclosure leads to a method for operating a drive unit of an electric bicycle. The drive unit in this case comprises the sensor system having the torque sensor. Preferably, the drive unit additionally comprises the shaft at which the torque is ascertained by way of the torque sensor. Preferably, the shaft forms a bottom bracket spindle of the electric bicycle. The method for operating the drive unit in this case comprises the described method for operating a sensor system. In addition, the method for operating the drive unit comprises the step of controlled operation of the drive unit as a function of the torque ascertained by way of the torque sensor, and preferably additionally as a function of the detected torque error.

Preferably, the controlled operation of the drive unit comprises operating the drive unit in a normal mode when the detected homogeneous magnetic flux density is smaller than a predetermined second threshold value, and operating the drive unit in a degradation mode when the detected homogeneous magnetic flux density is greater than or equal to the predetermined second threshold value. Preferably, the second threshold value corresponds to the first threshold value. In the normal mode, the ascertained torque is used as an input variable of a drive-unit controller. In the degradation mode, a degraded torque is used as an input variable of the drive-unit controller. The degraded torque in this case is smaller than the torque ascertained by way of the torque sensor. In other words, the drive unit is operated in at least two different operating modes, namely the normal mode and the degradation mode. In the degradation mode, the torque actually detected by way of the torque sensor is not used as the input variable for controlling the drive unit, but rather the degraded torque, which is smaller. That is to say, in the degradation mode, control of the drive unit is carried out based on a smaller torque. This particularly advantageously takes into account the case of overestimation of the torque detected by way of the torque sensor in the presence of interfering external magnetic fields. That is to say, when a torque error is detected, the measured torque is reduced, and this reduced value is used as a basis for the motor controller. In particular, in control of the drive unit in such a way that the generated motor torque is proportional to the ascertained torque at the shaft, this prevents an undesirably excessive motor torque from being generated or torque from being processed by the drive unit which originates from magnetic interference. For example, when moving off from standstill or when motor assistance resumes from coasting, after an end and a new beginning of pedaling, a certain torque threshold must be exceeded. In the degradation mode, it may, in particular, be prevented that this threshold is exceeded by an external magnetic field without intention on the part of the rider. A certain operational safety of the electric bicycle may thus be increased in a particularly simple and efficient manner.

More preferably, the degraded torque is determined by subtracting a predetermined constant degradation torque from the detected torque. Preferably, the constant degradation torque amounts to at least 2 Nm, in particular, to a maximum of 20 Nm. This allows the method to be carried out in a particularly simple, efficient, and cost-effective manner.

More preferably, the degraded torque is determined by way of the following formula:

$${T}_{deg} = {T}_{meas} - ( {B}_{meas} - {B}_{limitDeg} ) * k$$

with the degraded torque T_{deg}, the detected torque Tₘₑₐₛ, the detected homogeneous magnetic flux density Bmₑₐₛ, the second threshold value B_{limitDeg}, and a constant k. In particular, a linear function for the degraded torque as a function of the detected homogeneous magnetic flux density is thus provided. A degradation mode optimally adapted with regard to high effectiveness and simultaneously high user comfort may thus be enabled with simple and efficient implementation of the method.

Further preferably, the method further comprises the step of: increasing a minimal starting torque during the degradation mode. The starting torque is regarded, in particular, as a minimum torque that must be detected at the bottom bracket spindle such that motor assistance by the drive unit may begin. That is to say, the rider must apply at least the minimum starting torque at the bottom bracket spindle such that the motor assistance of the drive unit commences. Preferably, the starting torque is increased in the degradation mode relative to the normal mode by a predetermined increase amount, for example, at least 2 Nm, preferably to a maximum of 10 Nm. The increase of the starting torque in the degradation mode results in that, in the presence of particularly strong external magnetic fields, a severely faulty detected torque, and thus a possibly undesired initiation of the motor assistance, may be avoided.

Preferably, the method further comprises the step of: preventing operation of the drive unit when the detected homogeneous magnetic flux density is greater than or equal to a third threshold value. In particular, the third threshold value is greater than the second threshold value. More preferably, the third threshold value corresponds to at least ten times a magnetic flux density of the Earth's magnetic field, preferably at least 500 μT, in particular, at least 700 μT. In particular, preventing operation of the drive unit is regarded as a deactivation of the motor assistance. That is to say, when the detected homogeneous magnetic flux density reaches or exceeds a particularly high value, namely the third threshold value, generation of the motor torque by way of the drive unit is controlled to prevent it. This results in that, in cases in which, due to a particularly strong external magnetic field and thus a likely particularly large torque error in the detected torque, the drive unit is deactivated as a safety function, in order to avoid, in particular, undesired malfunctions and motor-torque generation.

Further preferably, the method further comprises the step of: filtering of the detected homogeneous magnetic flux density by way of a low-pass filter. Thus, the detected data are smoothed at least slightly, such that the resulting torque corrections are influenced only minimally by sensor noise. In this way, the riding feel and thus the riding comfort for the user of the electric bicycle may be increased.

Preferably, the second threshold value and/or the third threshold value is adapted as a function of sensitivity differences of sensor elements of the torque sensor. Preferably, in the case of detected, in particular, high, sensitivity differences, the second threshold value and/or the third threshold value is reduced. That is to say, when significant or high sensitivity differences between sensor elements of the torque sensor are detected, the second threshold value and/or the third threshold value is automatically lowered such that the degradation mode is triggered earlier, that is to say at lower homogeneous magnetic flux densities, and/or such that switching off the drive unit occurs at lower magnetic flux densities compared with the case in which no or only small sensitivity differences are detected. Such sensitivity differences may occur, for example, due to the design and/or due to aging or similar effects between the sensor elements. Thus, faulty torque measurements, which may occur to an increased extent, for example, in cases of high sensitivity differences, may be countered in a particularly reliable and early manner by substitute reactions or by deactivation, in a particularly simple and effective way.

Preferably, the second threshold value and/or the third threshold value is increased in response to detection of low sensitivity differences, in particular, or in response to recognition of no sensitivity differences. Preferably, in this case, at the start of the method, that is to say, in particular, at an operating start of the electric bicycle, it is assumed that sensitivity differences between the sensor elements are possible. Subsequently, in operation of the electric bicycle, an ascertainment is carried out as to whether sensitivity differences are present or are small. This may preferably be effected in that, when a certain minimum homogeneous magnetic flux density is detected, the ascertained torque values are analyzed. If the torque values ascertained in this way are small, it is assumed that the sensitivity differences are also small. In response, the second threshold value and/or the third threshold value is increased. A particularly reliable and efficient method may thus be provided, which may, as a function of the sensor properties, provide optimal safety in generation of motor assistance by way of the drive unit and optimal riding comfort.

Furthermore, the disclosure relates to an electric bicycle having a drive unit with a sensor system, wherein the sensor system comprises a torque sensor which is formed as a magnetoelastic sensor. The sensor is configured such that, based on detection of changes in a magnetic field, a torque at a shaft is ascertained. The electric bicycle furthermore comprises a control unit which is configured to carry out the described method for operating the sensor system or the method for operating the drive unit of the electric bicycle.

Further disclosed is a method for operating an electric bicycle, wherein the electric bicycle comprises, in particular, a drive unit and a sensor system having a torque sensor. The method comprises the described method for operating a drive unit of an electric bicycle. The method further comprises the steps of:
ascertaining an assistance interruption of the drive unit during controlled operation of the drive unit, and
outputting information regarding the ascertained assistance interruption, by way of an output unit, to a user of the electric bicycle.
   The ascertaining of the assistance interruption may preferably comprise detecting a non-driven state of the drive unit, in which, in particular, no motor torque is generated by the drive unit. Preferably, the ascertaining of the support interruption is carried out based on the sensor and/or based on an instantaneous state of the drive-unit controller. Preferably, information is communicated to the user that an assistance interruption is currently present and/or that an assistance interruption has been detected. In other words, a targeted indication is displayed to the user, by way of which the user is explicitly informed of the detected assistance interruption. This allows, in a simple and reliable manner, an automatic display of particularly detailed information regarding the instantaneous operating state of the electric bicycle. For example, this may allow the rider to be specifically shown that the special state of the assistance interruption has also been detected by the system. For example, this results in the advantage that the user becomes aware that the system is aware of the special state of the assistance interruption, even though motor assistance might be desired at that moment. Thus, the probability may be reduced, in particular, that the user assumes a defect or a malfunction of the electric bicycle and, for example, initiates maintenance or repair. Thus, in other words, a particularly high user comfort of the electric bicycle may be enabled.

Preferably, output of the information regarding the ascertained assistance interruption takes place only when the ascertained degraded torque is smaller than or equal to a predetermined minimum torque, in particular, zero. That is to say, output of the information takes place on the one hand only in the degradation mode and, on the other hand, only when the degraded torque is smaller than or equal to the predetermined minimum torque. Preferably, the minimum torque corresponds to a threshold value below which the drive-unit controller generates a motor torque of zero. That is to say, the information is output only when the special case occurs in which the torque is reduced by the degradation mode and when, during that time, no motor torque is generated due to the degraded torque.

Preferably, the method furthermore comprises the step of: detecting a pedal actuation of the electric bicycle by the user, wherein the ascertaining of the assistance interruption and the output of the information are carried out, in particular only, when a pedal actuation is detected. That is to say, ascertaining the assistance interruption and output of the information regarding it take place only during a pedal actuation that is detected, in particular, sensor-based. That is to say, the information is output only when the user is pedaling, in particular, with low pedal torque and low cadence. Unnecessary output of the information may thus be prevented, for example, in other cases in which no motor torque is generated.

Preferably, the method further comprises the step of detecting a speed of the electric bicycle by the user, wherein the ascertaining of the assistance interruption and the output of the information are carried out, in particular only, when the detected speed is greater than or equal to a predetermined minimum speed. In particular, the minimum speed amounts to at least 2 km/h. This results in the information output being effected only when the electric bicycle is being ridden, that is to say when it is moving.

Further preferably, the method further comprises the step of: detecting a resumption of motor assistance of the drive unit, and increasing a counter in response to a detected resumption of the motor assistance after a detected assistance interruption. The information is output only when the counter reaches or exceeds a predetermined counter value. For example, the predetermined counter value has at least the value 2, in particular, at least the value 3, preferably to a maximum of the value 10. The assistance interruption and the resumption of the motor assistance are perceived by the rider as “jerks”. By increasing the counter at each such “jerk,” the information is output only after a certain number of occurrences. Excessively frequent output of the information, for example, in the case of only individual interruptions of motor assistance, may thus be avoided.

### BRIEF DESCRIPTION OF THE DRAWINGS

An exemplary embodiment of the disclosure is described in detail below with reference to the accompanying drawings. In the drawing is:

FIG. 1 a simplified schematic view of an electric bicycle in which a method according to a preferred exemplary embodiment of the disclosure is carried out,

FIG. 2 a highly simplified schematic view of a sensor system of the electric bicycle of FIG. 1,

FIG. 3 a highly simplified schematic view of the method according to the preferred exemplary embodiment,

FIG. 4 a highly simplified schematic view of different operating modes of the method of the preferred exemplary embodiment, and

FIG. 5 simplified schematic views of signal progressions during the execution of the method according to the preferred exemplary embodiment.

### DETAILED DESCRIPTION

Preferably, all identical components, elements, and/or units are provided with the same reference signs in all figures.

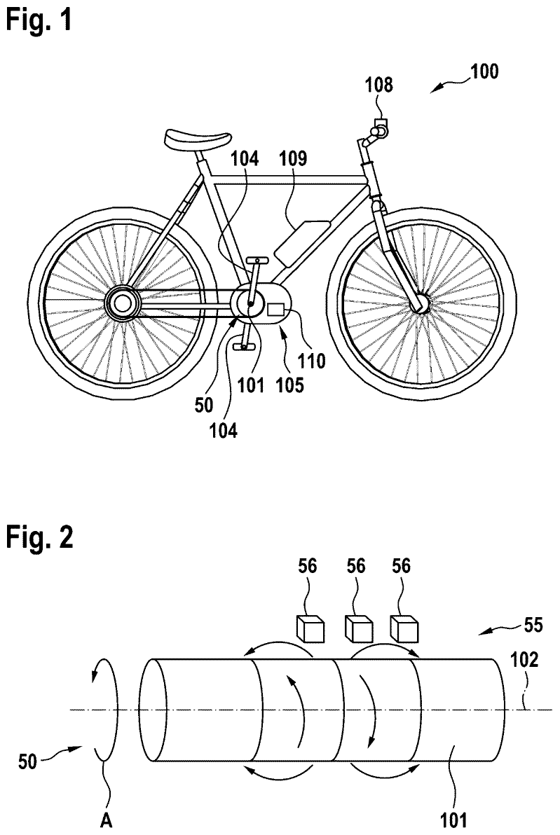

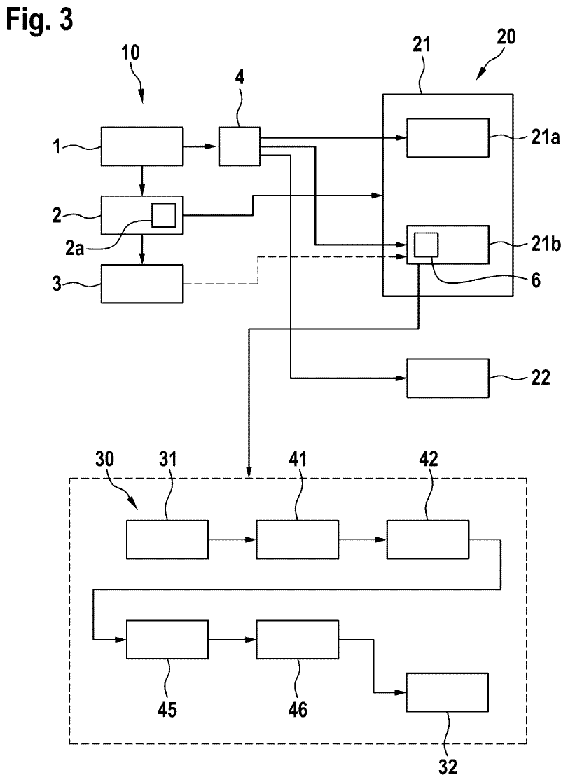

FIG. 1 shows a simplified schematic view of an electric bicycle 100, in which a method 20 for operating a drive unit 105 of the electric bicycle 100 is carried out according to a preferred embodiment of the disclosure. In FIG. 3, a highly simplified schematic view of the method 20 is shown. The method 20 further comprises, according to a further aspect of the disclosure, a method 10 for operating a sensor system 50 of the electric bicycle 100.

The drive unit 105 of the electric bicycle 100 comprises a motor which is, in particular, an electric motor. The motor is supplied with electrical energy by way of an electrical energy storage 109 of the electric bicycle 100. The drive unit 105 is arranged in the region of a bottom bracket of the electric bicycle 100. By way of a motor torque generated by the motor of the drive unit 105, a pedaling force produced by muscular power of a rider of the electric bicycle 100 may be motorically assisted. The rider's muscular power may be applied via a crank mechanism having cranks 104.

In particular, by way of the cranks 104, the pedaling force may be transmitted to a shaft 102 which, in particular, corresponds to a bottom bracket spindle of the electric bicycle 100. To the shaft 102, the assisting motor torque of the motor of the drive unit 10 is preferably additionally transmitted, preferably, via a transmission.

Operation of the drive unit 105 is controlled by way of a control unit 110 of the electric bicycle 100. The control unit 110 is additionally configured to carry out the method 20.

In operation of the drive unit 105, the drive unit 105 is actuated under control so as to generate the motor torque as a function of the pedaling torque produced by the user, that is to say as a function of the torque at the shaft 101.

Detection of the torque at the shaft 101 takes place by way of the sensor system 50 and the method 10 for operating the sensor system 50.

The sensor system 50 comprises a torque sensor 55 which is formed as a magnetoelastic sensor. In detail, the torque sensor 55 comprises a total of three sensor elements 56, which are arranged next to one another along a direction parallel to the axis 102 of the shaft 101, in particular, at uniform distances (compare FIG. 2). The torque sensor 55 is configured such that, based on detection of changes in a magnetic field, the torque at the shaft 101 is ascertained.

In detail, the torque sensor 55 is configured to detect the changes in the magnetic field and, in detail, to detect a homogeneous magnetic flux density along the axis 102 of the shaft 101. Alternatively or additionally, the torque sensor 55 may be formed to detect properties of the acting magnetic field along further axes. For example, the torque sensor 55 may alternatively preferably be formed as a three-axis sensor.

In the method 10 for operating the sensor system 50, a detection 1 of the homogeneous magnetic flux density along the axis 102 takes place first by way of the torque sensor 55. Simultaneously, an ascertaining 2 of the instantaneous torque on the shaft 101 is carried out by way of the torque sensor 55.

The torque is determined as the instantaneous pedaling torque on the shaft 101 applied by the user of the electric bicycle through muscular force. The calculation is carried out by way of the control unit 110 based on the magnetoelastic measurement principle of the torque sensor 55.

The ascertainment 2 of the torque additionally comprises compensating 2 for the homogeneous magnetic flux density detected in step 1. That is to say, an instantaneously acting homogeneous magnetic field is compensated, in particular by known calculation methods, such that the influence of the homogeneous magnetic field is factored out and the actual torque on the shaft 101 is ascertained with particular precision.

Furthermore, in the method 10, recognition 3 of a torque error in the torque ascertained in step 2 takes place when the homogeneous magnetic flux density detected in step 1 is greater than or equal to a predetermined first threshold value.

The first threshold value is preferably a sensor-specific constant value, which, for example, is based on a calibration and corresponding parameterization of the measurement technology of the sensor system 50, and is, in particular, known beforehand.

In particular, it is detected as a torque error that the torque ascertained in step 2 is greater than the torque actually present at the shaft 101. That is to say, when a torque error is detected, the torque ascertained by way of the torque sensor 55 constitutes an overestimation of the actual torque.

The results or measured values of the method 10 may then be used further for subsequent operation of the electric bicycle 100, as described below.

The method 20 for operating the drive unit 105 comprises controlled operation 21 of the drive unit 105 as a function of the ascertained torque.

Preferably, operation 21 of the drive unit 105 takes place such that a target motor torque that is to be generated by the drive unit 105, and, in particular, is specified by corresponding control by way of the control unit 110, corresponds to the torque ascertained in step 2 multiplied by an assistance factor. Preferably, one or more different constant values are used as the assistance factor, which may, in particular, be adjusted by a user by manually setting a desired assistance mode.

Additionally, controlled operation 21 of the drive unit 105 takes place as a function of the homogeneous magnetic flux density detected in step 1.

In detail, operation 21 of the drive unit 105 comprises two different operating modes, which are selected as a function of the detected homogeneous magnetic flux density.

Before use in step 21, filtering 4 of the detected homogeneous magnetic flux density takes place by way of a low-pass filter in order to smooth strongly fluctuating magnetic fields.

If the detected homogeneous magnetic flux density is less than a predetermined second threshold value, operation of the drive unit 105 takes place in a normal mode 21a. In the normal mode 21a, the torque ascertained in step 2 is used as an input variable of a drive-unit controller. That is to say, the torque detected by way of the torque sensor 55 is used directly for controlling the drive unit 105.

If the detected homogeneous magnetic flux density is greater than or equal to the predetermined second threshold value, operation of the drive unit 105 takes place in a degradation mode 21b. In the degradation mode 21b, a degraded torque that is smaller than the ascertained torque is used as an input variable of the drive-unit controller.

The degraded torque is determined by subtracting a degradation torque from the detected torque. The degradation torque may, for example, comprise a predetermined constant value. Alternatively, the degradation torque is preferably calculated based on a linear relationship between the detected torque, the detected homogeneous magnetic flux density, the second threshold value, and a predetermined constant.

Preferably, the second threshold value corresponds to the first threshold value. In particular, the step of detecting 3 the torque error may thus also be used as a trigger for the degradation mode 21b.

Furthermore, in the method 20, if the detected homogeneous magnetic flux density reaches or exceeds a third threshold value, prevention 22 of operation of the drive unit 105 takes place. The third threshold value preferably corresponds to a multiple of the second threshold value, in particular, at least three times the second threshold value.

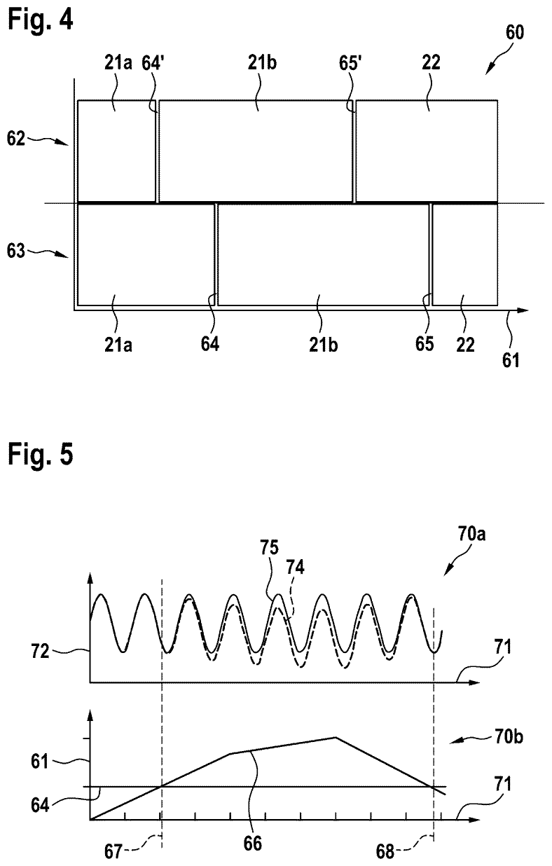

FIGS. 4 and 5 illustrate the processes in operation of the electric bicycle 100. In FIG. 5, simplified schematic diagrams for a torque progression (in diagram 70a) and a simplified exemplary schematic progression of a homogeneous magnetic flux density (in diagram 70b) are shown. In both diagrams 70a and 70b, the respective progressions are each shown over a time 71. Above, the torque 72 and, below, the homogeneous magnetic flux density 61 are designated as the vertical axis. Shown are the detected torque progression 75, the degraded torque progression 74, and the progression 66 of the detected homogeneous magnetic flux density. For example, this progression 66 may occur when passing through a strong magnetic field.

As can be ascertained in the lower diagram 70b, the progression 66 exceeds the second threshold value 64 at a first point in time 67 and falls below it again at a second point in time 68. Before and after these points in time 67 and 68, the drive unit 105 is thus operated in the normal mode 21a, in which no degradation of the torque occurs. Between these two points in time 67 and 68, the degradation mode 21b is executed, in which the detected torque 75 is degraded, that is to say reduced, to obtain the degraded torque progression 74. This degraded torque progression 74 is used for controlling the drive unit 105.

Furthermore, an extension of the method 20 may be carried out, wherein sensitivity differences of sensor elements 56 of the torque sensor 55 are taken into account. Shown in FIG. 4 are two different cases 62 and 63, wherein case 63 corresponds to the normal case described above with the second threshold value 64 and third threshold value 65, as well as the usual execution of the normal mode 21a, the degradation mode 21b, and the preventing 22 of the operation of the drive unit 105 as a function of the threshold values 64, 65 and the detected homogeneous magnetic flux density 61. This case 63 corresponds to a case wherein no sensitivity differences are assumed between the sensor elements 56 of the torque sensor 55.

In the other case 62, it is assumed that sensitivity differences may be present between the sensor elements 56. In this other case, adapted threshold values are used, namely an adapted second threshold value 64′ and an adapted third threshold value 65′. The adapted threshold values 64′ and 65′ are smaller than the threshold values 64 and 65 used for case 63 without sensitivity differences. Preferably, the adapted threshold values 64′ and 65′ are each reduced by a predetermined percentage, for example, of at least 10%, relative to the threshold values 64 and 65. This achieves that the degradation mode 21b and the preventing 22 of operating the drive unit 105 occur earlier, that is to say at lower homogeneous magnetic flux densities 61.

Preferably, when accounting for sensitivity differences according to FIG. 4, the operation of the electric bicycle 100 is carried out such that, initially, at a start of operation of the electric bicycle 100, operation is assumed to correspond to the case 62 with possible sensitivity differences, and this case is started first. During operation of the electric bicycle 100, switching into the other case 63 may occur when, based on the measured values of the sensor system 50, it is detected that no or only small sensitivity differences are present between the sensor elements 56. This is preferably possible when, during a detected homogeneous magnetic flux density that is, for example, greater than the adapted second threshold value 64′, a low torque is detected. It may then be assumed that no or only small sensitivity differences are present, which would otherwise lead to a larger torque error and thus to a larger torque.

According to a further aspect of the disclosure, a further method 30 for outputting information during operation of the electric bicycle 100 is additionally preferred (compare FIG. 2).

The method 30 is executed when the degradation mode 21b is active.

In the method 30, an ascertaining 31 of an assistance interruption of the drive unit 105 occurs during controlled operation, in particular, during the degradation mode 21b.

The assistance interruption is preferably detected in that the actual or intended motor assistance falls to zero. Alternatively or additionally preferably, the detection 31 of the assistance interruption occurs when the degradation mode 21b causes the degraded torque to be set to zero or to a negative value.

Furthermore, a detection 41 of a pedal actuation of the electric bicycle 100 by the user, an ascertaining 42 of a speed of the electric bicycle 100, a detection 45 of a resumption of motor assistance of the drive unit 105, and an increment 46 of a counter occur in response to each detected resumption of motor assistance after each detected assistance interruption. In particular, the counter is increased only when, during the respective assistance interruption, a positive pedal actuation and a positive speed of the electric bicycle 100 are detected.

When the counter reaches or exceeds a predetermined counter value, an output 32 of information regarding the ascertained assistance interruption is subsequently carried out via an output unit 108 of the electric bicycle 100 to the user of the electric bicycle 100.

For example, it may be specifically displayed to the rider on a display of the output unit 108 that an assistance interruption has been detected. Alternatively or additionally, a notice may be given to the user that they should continue riding and/or that no defect or error is present. This may, in particular, make the user aware that the assistance interruption and the subsequent resumption of motor assistance, which may lead to perceptible jolts while riding the electric bicycle 100, is a system-related effect of the operating mode of the electric bicycle 100, for example, due to environmental influences. Thus, it may be indicated, for example, that no unknown defect or unknown malfunction of the electric bicycle 100 is present, which may, in particular, improve acceptance of the perceptible jolts and avoid an impression of potential defects or malfunctions.

What is claimed is:

1. A method for operating a sensor system of an electric bicycle, wherein the sensor system includes a torque sensor formed as a magnetoelastic sensor and configured to ascertain a torque on a shaft based on a detection of changes of a magnetic field, the method comprising:
detecting a homogeneous magnetic flux density by way of the torque sensor;
ascertaining a torque on the shaft by way of the torque sensor; and
detecting a torque error of the ascertained torque when the detected homogeneous magnetic flux density is greater than or equal to a predetermined first threshold value.

2. The method according to claim 1, wherein the ascertaining of the torque comprises compensating the homogeneous magnetic flux density.

3. The method according to claim 1, wherein the detecting of the homogeneous magnetic flux density occurs along an axis of the shaft.

4. The method according to claim 1, wherein the first threshold value comprises a sensor-specific constant value.

5. A method for operating a drive unit of an electric bicycle, wherein the drive unit includes the sensor system, the method comprising:
the method according to claim 1; and
a controlled operation of the drive unit as a function of the ascertained torque and the detected torque error.

6. The method according to claim 5, wherein the controlled operation of the drive unit, comprises:
operating the drive unit in a normal mode when the detected homogeneous magnetic flux density is smaller than a predetermined second threshold value, and
operating the drive unit in a degradation mode when the detected homogeneous magnetic flux density is greater than or equal to the predetermined second threshold value,
wherein, in the normal mode, the ascertained torque is used as an input variable of a drive-unit controller,
wherein, in the degradation mode, a degraded torque is used as an input variable of the drive-unit controller, and
wherein the degraded torque is smaller than the ascertained torque.

7. The method according to claim 6, wherein the degraded torque is determined by subtracting a predetermined constant degradation torque from the detected torque.

8. The method according to claim 6, wherein the degraded torque is determined by way of the formula:
$${T}_{deg} = {T}_{meas} - ( {B}_{meas} - {B}_{limitDeg} ) * k$$
wherein the degraded torque is T_{deg}, the detected torque is Tₘₑₐₛ, the detected homogeneous magnetic flux density is Bₘₑₐₛ, the second threshold value is B_{limitDeg}, and a constant is k.

9. The method according to claim 6, further comprising:
increasing a minimum starting torque during the degradation mode.

10. The method according to claim 5, further comprising:
preventing the operation of the drive unit when the detected homogeneous magnetic flux density is greater than or equal to a third threshold value.

11. The method according to claim 1, further comprising:
filtering the detected homogeneous magnetic flux density by way of a low-pass filter.

12. The method according to claim 6, wherein the second threshold value and/or the third threshold value is configured as a function of sensitivity differences of sensor elements of the torque sensor.

13. The method according to claim 12, wherein the second threshold value and/or the third threshold value is increased in response to a detection of low sensitivity differences.

14. An electric bicycle, comprising:
a drive unit having a sensor system, wherein the sensor system includes a torque sensor formed as a magnetoelastic sensor and configured to ascertain a torque on a shaft based on a detection of changes of a magnetic field, and
a control unit configured to carry out the method according to claim 1.
